(19) United States
(12) Patent Application Publication
(10) Pub. No.: US 2024/0112208 A1
(43) Pub. Date: Apr. 4, 2024

(54) Systems and Methods for Assessing Extractability of Prospective Helium-Natural Gas Sources

(71) Applicant: Rodrick William Lekey, Gravois Mills, MO (US)

(72) Inventor: Rodrick William Lekey, Gravois Mills, MO (US)

(21) Appl. No.: 17/936,888

(22) Filed: Sep. 30, 2022

(51) Int. Cl. G06Q 30/02

(52) U.S. Cl. CPC G06Q 30/0202; G06Q 30/0205

(57) ABSTRACT

This invention is using Artificial intelligence (“AI”) as a tool to determine the amount of helium in a specific geological setting. This AI system will be utilized by small business in order for them to keep up with the demanding market. The conceptual framework was based on economics of small businesses, factors leading to their failure, the helium industry, and AI use by large businesses.

### TECHNICAL FIELD OF THE INVENTION

This invention relates generally to systems and methods for assessing extractability of prospective helium-natural gas sources in the form of software performs various financial and technical analyses to assess available electronic source data for determining the amount and complexity of extracting Helium in order to make an economic viability determination as to whether the cost of extraction is worth the sales value of the gas extracted.

This invention relates generally to systems and methods for assessing extractability of prospective helium-natural gas sources in the form of Artificial Intelligence (AI) machines analyzing available (electronic and physical data) research to conjure economic viability evaluation criteria and analyze various relevant data corpuses in order to determine whether there exists an economically viable Helium gas supply available for extraction from a well.

This invention relates specifically to the use of AI in order to derive and test artificially constructed evaluation criteria and heuristics based on known research (electronic and physical data) and hypothesis in order to identify economically viable prospective sources of Helium gas without the expense and time of conducting research projects in order to be able to compete with larger businesses having more resources to enable exploration. This invention relates specifically to the use of AI for this purpose by small business to conduct low-cost high-speed conjectural and theoretical Helium gas exploration experiments and then determining the potential forecasted costs of extraction of Helium and the potential forecasted quantities of Helium available in a given well.

This invention relates generally to the use of AI to identify and collect potentially relevant data elements and theories regarding extractability of Helium in wells from both electronic and physical data sources. This invention relates more specifically to this use of AI by small business to create and test conjectures and theories related to the extractability of Helium from wells.

### BACKGROUND

Today artificial intelligence machines are used for many and varied purposes. The use of AI machines to enable processing and analysis of large quantities of data to derive more simplistic evaluation criteria and help people make decisions is present in marketing prediction, credit fraud detection, warranty analysis, personalized marketing, customer service, and custom health care plans. Uses include navigation, automated recommendations, voice recognition, facial recognition, image transformation, object tracking, and autonomous drone operation as well.

What is not present in the prior art is a method of collecting conjectural or theoretical analyses propositions from electronic and physical data sources to create and test evaluation criteria that are conjectural, theoretical, not completely implemented, not commonly or well known, not vetted by peer review, or are even contrary to existing practice standards for conjectural or theoretical reasoning to propose a new likelihood for demonstrating the presence of Helium gas in a well.

In light of the foregoing prior art, there is a need for a method of leveraging AI machines (software and hardware technologies collectively) to derive and test artificially constructed evaluation criteria and heuristics based on known research (electronic and physical data) and hypothesis in order to identify economically viable prospective sources of Helium gas without the expense and time of conducting research projects to conduct low-cost high-speed conjectural and theoretical Helium gas exploration experiments and then determine potential forecasted costs of extraction of Helium and potential forecasted quantities of Helium available in a given well.

### BRIEF SUMMARY OF THE INVENTION

According to a first aspect of the invention there is a system and method for assessing extractability of prospective helium-natural gas sources comprising a well evaluation system to create a helium-extractability determination for a well comprising a plurality of extractability-criteria, one of said plurality of extractability-criteria comprising a viability-heuristic having a predictive-indicator, a plurality of information sources, one of said plurality of information sources being a geographic database, an algorithm, an input device, a database comprising said plurality of extractability-criteria, said plurality of information sources, an operational connection to a plurality of artificial intelligence data corpuses one of said plurality of artificial intelligence data corpuses being a helium-source-data corpus, and a processor, wherein a user uses said input device for collecting an electronically available data, wherein said processor uses said algorithm for organizing and storing said electronically available data among said plurality of information sources in said database, wherein said processor uses said algorithm for electronically harvesting and collecting said extractability-criteria from said plurality of information sources, and wherein said processor uses said algorithm for synthesizing and arranging said plurality of information sources and said extractability-criteria into an artificial intelligence knowledge corpus stored in said database, wherein said processor uses said algorithm for electronically processing a plurality of business framework conceptual topics and theoretical topics, one of said plurality of business framework conceptual topics and theoretical topics being said extractability-criteria comprising said viability-heuristic having said predictive-indicator then using said extractability-criteria to determine said helium-extractability by mining said artificial intelligence knowledge corpus for information to determine extractability-criteria based on said plurality of business framework conceptual topics and theoretical topics, and wherein said processor uses said algorithm for evaluating said well to report said helium-extractability determination.

According to an alternate embodiment of the first aspect of the invention there is a system and method for assessing extractability of prospective helium-natural gas sources comprising a well evaluation system to create a helium-extractability determination for a well wherein said artificial intelligence knowledge corpus and/or said further comprises an artificial intelligence neural network.

According to an alternate embodiment of the first aspect of the invention there is a system and method for assessing extractability of prospective helium-natural gas sources comprising a well evaluation system to create a helium-extractability determination for a well wherein a user uses said input device to enter a well-designation to identify a well and said well-designation is transmitted to said database in the form of non-transitory computer-readable media.

According to an alternate embodiment of the first aspect of the invention there is a system and method for assessing extractability of prospective helium-natural gas sources comprising a well evaluation system to create a helium-extractability determination for a well wherein said user further uses said input device for collecting a physically available data, wherein said processor uses said algorithm for organizing and storing said physically available data among said plurality of information sources in said database, wherein said processor uses said algorithm for electronically harvesting and collecting said extractability-criteria from said plurality of information sources, and wherein said processor uses said algorithm for synthesizing and arranging said plurality of information sources and said extractability-criteria into an artificial intelligence knowledge corpus stored in said database.

According to second aspect of the invention there is a method of creating a helium-extractability determination to determine whether a well contains an extractable-helium supply comprising identifying an information sources (IS) each IS having a plurality of evaluation-criteria (EC) each EC having a plurality of data-evaluation-elements (DEE) one of said plurality of DEE being for example a scaled value between zero and one then creating said EC from said DEE to identify an extractable-helium supply by creating a viability-heuristic (VH) having a plurality of predictive-indicators (PI) each based on applying a viability-rule (VR) to said DEE then repeating said creating a VH step to create a plurality of PI whose number is determined by the quantity present of said DEE then repeating said creating an EC step to create said plurality of EC as determined by the quantity present of said EC within each IS then repeating said identifying an IS step to create a plurality of IS, identifying a helium-source-data source (HSDS) having a plurality of data-elements (DE) then creating a helium-source-data corpus (HSDC) from said HSDS by capturing in an electronic format said plurality of DE, formatting said DE for a relational data storage, and importing said DE into said helium-source-data corpus, repeating said capturing in an electronic format step to import said plurality of DE, and repeating said identifying a HSDS step to create a plurality of HSDC, analyzing said plurality of HSDS using said plurality of EC, and generating said helium-extractability determination for said well.

According to an alternate embodiment of the second aspect of the invention there is a method of creating a helium-extractability determination to determine whether a well contains an extractable-helium supply wherein said analyzing said plurality of HSDS step and/or said helium-extractability determination step further comprises processing within an artificial intelligence knowledge corpus and/or an artificial intelligence neural network.

According to third aspect of the invention there is a method of creating a helium-extractability determination to determine whether a well contains a helium supply comprising collecting an electronic data source (EDS) having a plurality of data-elements (DE) related to helium-extractability and electronically harvesting/collecting said plurality of DE, synthesizing and arranging said plurality of DE into an artificial intelligence knowledge corpus, and repeating said collecting an EDS step to create a plurality of EDS, collecting an physical data source (PDS) having a plurality of data-elements (DE) related to helium-extractability and electronically harvesting/collecting said plurality of DE, synthesizing and arranging said plurality of DE into said artificial intelligence knowledge corpus, and repeating said collecting an PDS step to create a plurality of PDS, electronically mapping a plurality of business framework conceptual topics and theoretical topics to derive a set of helium supply viability criteria, evaluating said plurality of DE using said a set of helium supply viability criteria, and reporting said helium-extractability determination to locate an economically extractable helium supply and report thereupon.

According to an alternate embodiment of the third aspect of the invention there is a method of creating a helium-extractability determination to determine whether a well contains a helium supply wherein said artificial intelligence knowledge corpus further comprises an artificial intelligence neural network.

An advantage of the present invention is the capability to derive and test artificially constructed evaluation criteria and heuristics based on known research (electronic and physical data) and hypothesis (hypotheses) in order to identify economically viable prospective sources of Helium gas without the expense and time of conducting research projects to conduct low-cost high-speed conjectural and theoretical Helium gas exploration experiments and then determine potential forecasted costs of extraction of Helium and potential forecasted quantities of Helium available in a given well.

The invention will now be described, by way of example only, with reference to the accompanying drawings in which:

### BRIEF DESCRIPTION OF THE DRAWINGS

FIG. 1, is a flowchart showcasing the Small Business AI Insertion Conceptual Frame Work;

FIG. 2 is a flowchart showcasing the Helium Small Business Study Conceptual Framework;

FIG. 3 is a flowchart showcasing the Current Helium Well Prospecting Workflow; and

FIG. 4 is a flowchart showcasing a method of determining whether a well contains an extractable-helium supply.

### DETAILED DESCRIPTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “one embodiment,” “an embodiment,” “an example embodiment,” etcetera, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Throughout this specification, the phrase “Information Sources”, or variations thereof such as “(IS)”, will be understood to imply the inclusion of original or duplicate repositories or bodies of data and knowledge, the form of which can be digital, physical, textual, graphical, or verbal and is relevant to a specific area of technology, science, or engineering pertaining to any portion of the entire resource extraction process. Specific examples include the Colorado Oil & Gas Conservation Commission website, the American Petroleum Institute designator numbering system, well log images, well completion notes, and many others.

Throughout this specification, the phrase “Evaluation Criteria”, or variations thereof such as “(EC)”, will be understood to imply the inclusion of determining the presence of specific factors or standards of interest that are derived from industry practices, academic literature or knowledgeable individuals and utilized to determine the useability and relevance of a particular repository. Examples include a specific API well's designation number, a specific well's neutron density log, a specific leaseholder in the COGCC website, an available well composition analysis, among many others.

Throughout this specification, the phrase “Data-Evaluation-Elements”, or variations thereof such as “(DEE)”, will be understood to imply the inclusion of determining the value or magnitude of a specific, relevant data point of interest, examples being a well production log showing previous production by month or a well analysis containing a helium value.

Throughout this specification, the phrase “Viability-Heuristic”, or variations thereof such as “(VH)”, will be understood to imply the inclusion of the numerous factors composed of local knowledge or past experience that is used to determine the feasibility of a project. An example is a shut-in, shallow well of less than 1000 feet depth that contains 4% helium, 950 btu gas composition, and lies 100 meters from a commercial pipeline is technically and financially feasible.

Throughout this specification, the phrase “Predictive-Indicators”, or variations thereof such as “(PI)”, will be understood to imply the inclusion of specific, measurable values whose presence and magnitude or complete absence provide guidance regarding the feasibility of a specific project. Examples include presence of a specific gas stream component, and varying levels of governmental rules that apply to well-drilling in a geographic area.

Throughout this specification, the phrase “Viability-Rule”, or variations thereof such as “(VR)”, will be understood to imply the inclusion of general rules of thumb in the context of local knowledge or past experience and is composed of numerous factors used as a go/no-go criteria for a project. Examples include less than 0.10% mole percent helium in a specific well or complete ban on drilling in a geographic area being no-go decision indicators.

Throughout this specification, the phrase “Helium-Source-Data Source”, or variations thereof such as “(HSDS)”, will be understood to imply the inclusion of an IS containing helium specific data and knowledge that is specifically relevant to the detection, discovery, exploration, exploitation, and/or production of helium in a general geographic region. Examples include academic journal articles on potential natural gas fields, state level records of helium production, well production notes suggesting non-flammable high flow gas, and field geology notes of stratigraphic traps.

Throughout this specification, the phrase “Data-Elements”, or variations thereof such as “(DE)”, will be understood to imply the inclusion of lowest level constituent, individual parts or entries of the numerical, textual, or graphical components within an IS. Examples are the specific, exact natural gas components of a specific well, or the specific, exact composition of a stratigraphic layer in a specific geological region.

Throughout this specification, the phrase “Helium-Source-Data Corpus”, or variations thereof such as “(HSDC)”, will be understood to imply the inclusion of a collection of knowledge and data comprised of a wide variety of source materials pertaining to Throughout this specification, the phrase “electronic data source”, or variations thereof such as “(EDS)”, will be understood to imply the inclusion of an IS that is specifically in a digital storage format and is retrieved over web infrastructure for local storage and manipulation.

Throughout this specification, the phrase “physical data source”, or variations thereof such as “(PDS)”, will be understood to imply the inclusion of an IS that is specifically in a physical form and is digitally recorded or transformed for local storage and manipulation.

Index of Labelled Features in Figures. Features are listed in numeric order by Figure in numeric order.

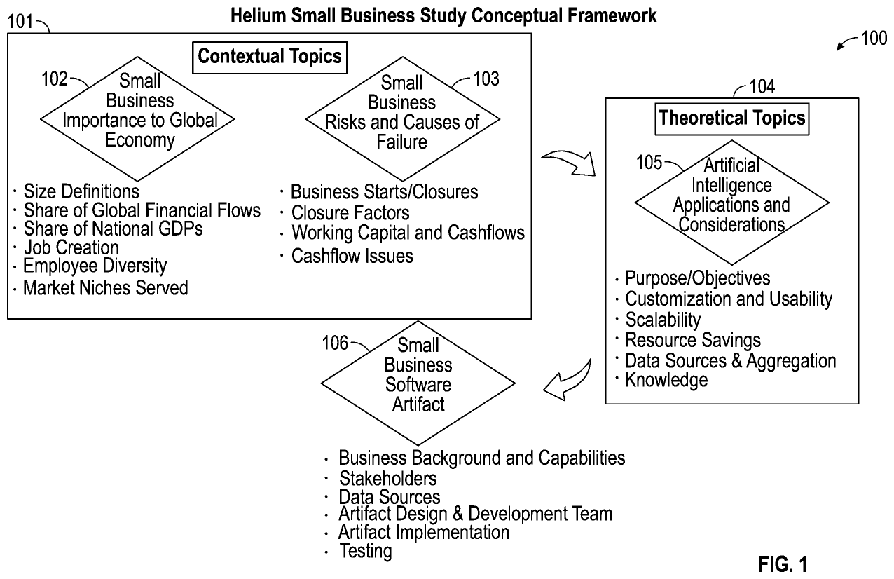

Referring to the figures, that is shown in FIG. 1 are the following features:

Element 100 is a flowchart showcasing the Helium small business study conceptual framework.

Element 101 are the contextual topics.

Element 102 is the small business important to the global economy, which include: Size definitions, share of global financial flows, share of national GDPs, job creation, employee diversity, and market niches served.

Element 103 is the small business risks and causes of failure, which include: Business start/closures, closure factors, working capital and cashflows, and cashflow issues.

Element 104 are the theoretical topics

Element 105, which include: purpose/objectives, stakeholders, customization and usability, scalability, resource savings, data sources & aggregation, knowledge, trend spotting, anomalies & early warning, risk mitigation and correction

Element 106 is the software artifact, which includes: business background, stakeholders, data sources, design & development, implementation, and testing

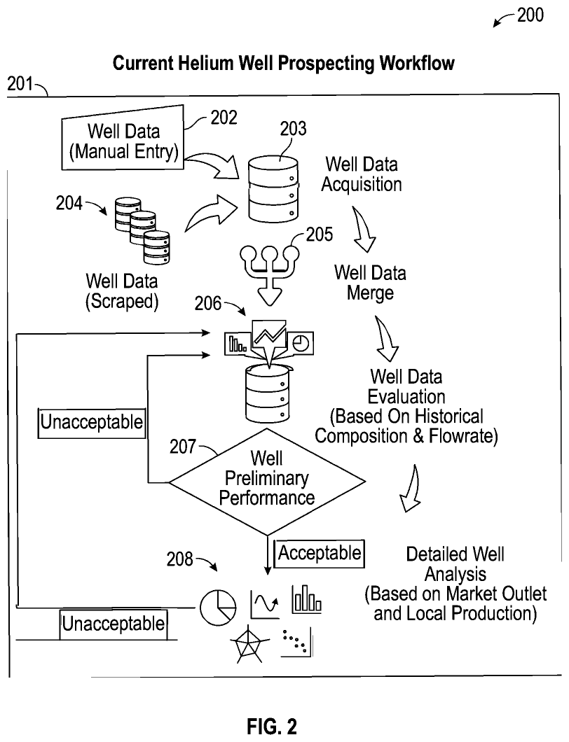

Referring to the figures, that is shown in FIG. 2 are the following features:

Element 200 is a flowchart showcasing current helium well prospecting workflow.

Element 202 is the manually entered well data.

Element 203 is the well data acquisition process.

Element 204 is scraped well data.

Element 205 is the well data merge.

Element 206 well data evaluation (based on historical composition and flow rate).

Element 207 is the analysis of the preliminary performance of the well.

Element 208 is the detailed well analysis (based on market outlet and local production).

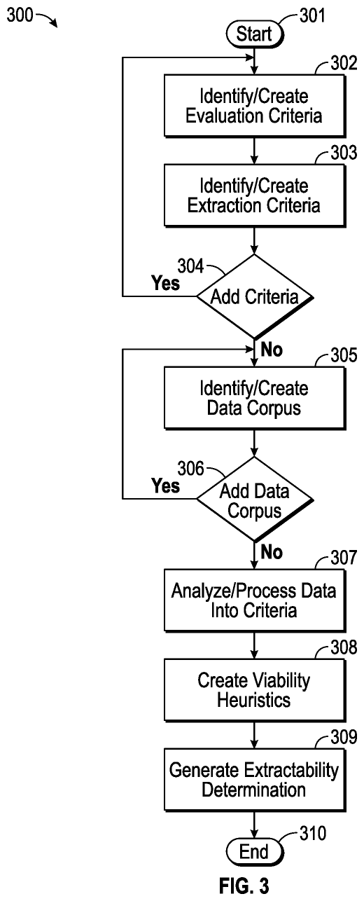

Referring to the figures, that is shown in FIG. 3 are the following features:

Element 300 is a flowchart showcasing a method of determining whether a well contains an extractable-helium supply.

Element 301 is the start of of identifying at least one information source that has at least one evaluation—criteria with at least one data evaluation—element.

Element 302 is identifying and creating an evaluation criteria.

Element 303 is identifying and creating an extractability criteria.

Element 304 is to add the criteria.

Element 305 is identifying and creating data corpus.

Element 306 is adding the data corpus.

Element 307 is analyzing/processing data into criteria

Element 308 is creating viability heuristics.

Element 309 is generating extractability determination.

Element 310 is the end of the process of determining whether a well contains an extractable-helium supply.

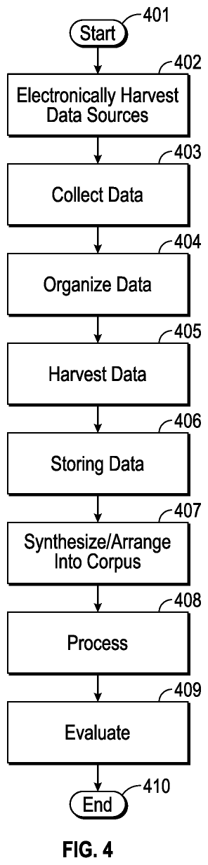

Referring to the figures, that is shown in FIG. 4 are the following features:

Element 400 is a flowchart showcasing a method of determining whether a well contains a helium supply.

Element 401 is a the start of the process of determining whether a well contains a helium supply.

Element 402 is collecting data into a data corpus.

Element 403 is organizing and storing data corpus.

Element 404 is harvesting and collecting data from a plurality of electronic data sources.

Element 405 is storing data in an AI Neural Network.

Element 406 is electronically harvesting and collecting data from printed data sources.

Element 407 is synthesizing and arranging harvested data into an artificial intelligence.

Element 408 is electronically processing business frame conceptual and theoretical topics to derive a set of evolution helium supply viability criteria.

Element 409 is evaluating data to locate an economically extractable helium supply and report thereupon.

The overall analogous or proxy business process for bringing a project from initial conception through completion and the specific, recursive steps are shown in FIG. 1. The researcher is the creator of the financial projection spreadsheets used in the business process and the workflow diagram. The artifact is a software architecture diagram that illustrates the changes needed to insert AI functionality into the business process for finding prospective wells for an analogous or proxy business in the helium industry.

The well prospecting process is outlined in FIG. 2 and shows the current manual workflows that are used for finding prospective helium wells. The AI architecture artifact is focused on specifically automating that well prospecting workflow and is shown in FIG. 3. The AI insertions and the functionalities of those insertions into the well prospecting workflow was the focus of the evaluation component of the study. A brief summary of the overall current workflows is included in the next section.

The overall workflow starts with manually searching through both on-line and in-house databases for analogous or proxy wells that have produced helium in the past. The topline data from the analogous well is run through a series of spreadsheets to determine the financial potential of the well given the current conditions. If the well appears to be viable, the detailed information on the well is pulled from the source and a more detailed evaluation is made that includes previous local production, current market outlet options, and current market conditions. The effort involves geologists, geophysicists, reservoir engineers, well driller/operators, and financial analysts.

In the analogous or proxy business, the next workflow steps include a detailed well flow model with an estimate of well depletion performance based on local history. The analysis also includes manually searching for recent or local terms and conditions from leaseholders, investors, and service providers. If this evaluation is considered viable, the prospective well enters the firm's deal funnel for further refinement and deal negotiation with all relevant stakeholders. Once the deal is fully negotiated and signed with all relevant participants, the well(s) enter the project phase to include engineering, state or federal permitting, well-drilling, well data collection, earthmoving, facility construction, well completion, and initial well testing. If at any point during the process the evaluation or the deal negotiation parameters become non-viable, the prospective well is returned to the initial well analysis stage and parameters are manually modified to determine if changes can be made that would result in a viable deal.

Once the well has shown initial flow, the production phase is entered. In the analogous or proxy business, this phase starts with testing of well flow rates and detailed chemical analysis of the well flow to confirm the composition of the gas. Using this information, the operator then determines the best method to ensure long-term well productivity and helps the team determine how to optimize well profitability based on experience and local heuristics. The actual flow-rates and composition are compared against the projected flow-rates and composition to determine if more well work is needed or if more refinement of the model is needed. Performance is tracked for the life of the well and if some projected parameter is off significantly in either direction, the team investigates to determine the cause and then make adjustments in the model, the projections, or the well itself. All data from the well is entered into the well database to help with prospecting for other viable analog wells.

In the analogous or proxy business, the well prospecting workflow is enlarged in FIG. 3. The workflow and the details behind it are discussed in this section in detail to help analyze likely insertion points for AI functionality to help automate that part of the workflow. That synthesis process was used to insert the relevant and applicable AI functions into the well prospecting workflow where automation was anticipated to improve and speed the workflow while being cognizant of the evaluation goals of reasonableness, realism, and feasibility.

The detailed prospective well workflow starts with a data repository that contains various data elements of previously drilled gas and oil wells, labeled Well Data Acquisition in FIG. 3. Some of the data is scraped from public websites such as the Colorado Oil & Gas Conservation Commission and the Kansas Geological Survey. Some of the well data comes from well analyses that have been collected and manually entered into the database starting in the late 1990s and continuously added through 2021. Usually, a well record will have a unique American Petroleum Institute (API) designator number that is based on the state and county that the well is located within. A typical well record and dataset consists of a drilling application and permit, a detailed geographic location, hand-written or digital well completion records, well log images, open flow test report, drill stem test reports, chemical analyses of the well flow composition and the amount of flow, neutron density logs, gamma ray density logs, sonic logs, acoustic logs, induction logs, depths of stratigraphic horizons, well engineering data, monthly production, annual production, and lease-holder information. The data files come in a variety of formats including .xls, .csv, .doc, .txt, .jpeg, .tif, .gif, .png, .pdf, and .html.

There may also be 3-D seismic information, stratigraphic data, gravitational data, geomagnetic data, geochemical data, reservoir, geographic information system (GIS), historical aero imagery, laser or light imaging detection and ranging data (LIDAR), satellite visual imagery, satellite synthetic aperture radar (SAR), satellite infrared imagery (IR), and satellite hyper-spectral data that covers the region surrounding the well. These files add specialized file formats for use in applications to decode and visually present the information to the user. Sometimes the team accesses this information on an ad hoc basis when searching an area for prospective wells. Sometimes the team accesses the data after a prospective well area has been identified to confirm initial assessment.

The well data merge workflow in FIG. 3 currently consists of ensuring that all of the data for a particular well is properly labeled and located within one container or folder. The work is focused on cleaning and labeling the data to help ensure that the team can rapidly find and integrate all known relevant information when a well prospecting evolution is started. At the current time, it is primarily a data quality assurance check for the team.

The well data evaluation workflow in FIG. 3 consists of a rapid assessment of a well's potential production using heuristics from previous experience with similar wells. The team usually needs a minimum of a production rate figure and a flow composition to do this rough estimate. These rules of thumb have been developed over many years and are generally specific to the area due to the team's operating experience in the area. At this point, a decision is made on whether to continue with the prospective well assessment. If the preliminary assessment shows the well to be unacceptable, the effort can either be stopped with the search continuing for another prospective well in the database, or the well development can be continued with modifications. The modifications are intended to improve results and include options such as combining the flow with other wells or applying treatments that remove production impediments such as de-watering.

The detailed well analysis workflow in FIG. 3 is accomplished with a series of well financial projection spreadsheets that have been developed over the years. Detailed information containing all known composition and flow data on the well is entered into the front-end spreadsheet and the calculations ripple through to linked back-end spreadsheets showing 5-year P&L statements, 5-year cashflow, investor payback schedule, and 5-year balance sheets results. Other details entered into the front-end spreadsheet include product pricing data, partner percentages and buy-in amounts, and capital expenditures for wells, plants, and equipment, and a start date. The usual and customary expenses are entered here as well and include well operation costs, depletion rates, inflation rates, royalty percentages, land leasing costs, utility and power, 3-D seismic, legal, administrative, accounting, permitting, and local tax rates.

The detailed well analysis incorporates current market outlet options, current market conditions, and previous local production to help the team make a go/no-go decision. If the results are acceptable, the team takes the prospective well into the detailed Well Financial Projection process. If the results are unacceptable, the team returns the well to the previous well data evaluation workflow to determine if some parameters can be adjusted that bring the prospective well into an acceptable state for further work. One last note regarding the front-end spreadsheets is that they are also linked to a master spreadsheet that contains all of the current API and analysis data for the wells in the area in which the analogous or proxy company operates. The linkage provides a rapid means to sort an entire state or region for a specific type of well, rate of production, or flow composition. The next section is a detailed list of all the corpora of knowledge that is utilized in assessing a prospective well.

The corpora that are used by the team to accomplish the well-prospecting workflows include the following data sources and workflow items. All these items were considered as candidates for inserting AI functionality:
1. County, State, and regional level stratigraphic corpora
2. County, State, and regional level geological corpora
3. County, State, and regional level reservoir/field corpora
4. Federal, State, and County drilling and well control regulations
5. Helium and natural gas regional geology corpus
6. American Petroleum Institute (API) corpus
7. Bureau of Land Management well report corpus and data
8. State well corpora and production data
9. Individual well data including production, composition, diagrams, and spectroscopy
10. Leasing, land work, and easements surrounding prospective well(s)
11. Prospective multi-well gathering system cost and system flow parameters
12. State Geographical Information System corpora and access
13. Pipeline corpus and Geographic Information System data
14. U.S. township, range, and section corpus
15. Latitude and longitude conversion corpus
16. Geomagnetic corpus and data
17. Aeromagnetic corpus and survey data
18. Aerogravity corpus and survey data
19. Geochemistry corpus and survey data
20. Spectroscopy corpus and regional data
21. 2-D/3-D seismic corpus
22. 2-D/3-D seismic data
23. Satellite imagery data in visual, IR, SAR, LIDAR, and hyperspectral formats
24. Lease availability and pricing data
25. Helium, natural gas, and natural gas liquids product pricing data

As the Helium Prospecting Workflow shown in FIG. 3 was analyzed for AI insertion and automation opportunities, the work products and the order of workflow was modified to accommodate the AI functions that were available or will soon be available. The specific workflow modifications and the AI insertions were decided upon using design science research principles. The geological knowledge is used to make a gross assessment of a prospective area and arrive at an understanding of its potential for further development. With the incorporation of automation, the prospecting process is accomplished in 3 steps.

The first step is a gross assessment of a field, county, or state and is based upon a baseline geological corpus that has been ingested from existing documentation. The second step is the assembly of a detailed helium corpus using similar, but different corpora that extend well beyond geology. The third step is a detailed assessment of a helium prospect based on in-depth knowledge of the entirety of the helium corpus. The individual corpora shown comprise the overall Baseline Helium Geology corpus and is important for assessing a county, region, or field to determine whether to expend further resources to investigate the prospective area. The question-and-answer capability is accomplished using different programs and models in each application, and the general approach is to read and classify the input texts. The implementations also search for claims and evidence in relevant documents and relate the arguments across the corpus.

The applications then use some type of reasoning model to deduce answers to questions that are pertinent to the corpus. In an ideal implementation, the system will also provide evidence for the answer that it has given that is understandable to the user.

The stratigraphic corpus provides clues to the presence of helium generating and helium trapping rock strata. In addition to understanding natural language, ingesting the stratigraphic corpora requires the ability to detect subtle differences in images depicting the different layers of rock that are encountered when drilling. The image classification capability required for this corpus is the ability to differentiate real-world pictures of sub-millimeter sized rock grains up to and including scaled images of rock layers that are hundreds of feet thick. The specific image classifiers that are potential AI insertions for this portion of the workflow include Google's Vision AI and Cloud AutoML, IBM's AI xplainability 360 toolkit, and Microsoft's InterpretML.

Ingesting the overall reservoir/field corpus has requirements beyond those of natural language understanding as well. The reservoir/field corpus will provide relevant factors regarding historical reservoirs and fields that have produced or are currently producing helium. The corpus should allow for finding geographic areas and geologic structures that are similar, but not currently producing helium. The reservoir/field corpus will also enable finding fields that produced helium in the past but have been abandoned or shut in with helium reserves left in place. The documents used here include spreadsheets that contain historical and up-to-date production of natural gas and oil. The reservoir/field corpus is also the first corpus that will likely need to be updated continuously as the spreadsheets are downloaded from state websites that are updated on a known basis, generally monthly. The AI insertion will need to be able to differentiate between two production products and know when the spreadsheet has most likely been updated by the state. The insertion will need to be robust enough to understand if an update has not occurred to avoid unnecessary downloading. Another consideration in obtaining regular updates is the bandwidth that is available to the user to download numerous and sometimes large files.

The final component of the baseline helium geology corpus is the helium and natural gas regional corpus. The helium and natural gas corpus insertion will help distinguish relevant factors found in helium-rich natural gas reserves and find factors that rule out reserves as having no helium production potential. The component has similar requirements with respect to the natural language understanding requirement of the corpus components above. An additional capability is the requirement to decipher hand-written forms dating back many decades. The well completion forms were submitted to state regulatory agencies and scanned into different file formats. The hand-written notes sometimes provide clues to prospective helium wells because of comments that discuss flammability, test results, and flow rates.

A final consideration for the Baseline Helium Geology Corpus and associated workflow is the need and frequency for updating the overall corpus due to new research that generates additions and changes in the academic literature. The state level professional associations also have the same issue, but it occurs on a less frequent schedule than the academic literature. Updating this aspect of the corpus will require access to the state association and journal websites by the AI insertion with the attendant login credentials. Validation approaches of the input will also be a consideration and may need to be modified for each data source. The assembly of and AI insertions into the Detailed Helium Prospecting corpus is the next step in the process of automating helium well prospecting. The overall corpus is composed of multiple corpora that are needed to complete an in-depth assessment of a well.

The Detailed Helium Prospecting corpus will also be needed to find existing wells that have been entered into the various state databases and have characteristics and production potential similar to proven helium wells. These various corpora include information that is specific to the analogous company's operations, such as proximity to a pipeline and county level well control regulations. The Detailed corpus will also incorporate information that is generally applicable to other small producers and is useful for integrating fine details of a project into financial projections. Example corpora include the range and township system, the API well designation system, converting latitude/longitude, magnetic and gravity survey data, spectroscopy information, 3D seismic information, satellite imagery, and regulations at the county, state, and federal level.

Automating several specific corpora will require similar AI capabilities as the Baseline Helium Geology corpus and will use similar tools. For instance, the geochemistry and spectroscopy corpora will need natural language understanding such as IBM DeepQA or OpenAI GPT-3. Those same corpora will also require an image recognition capability to interpret the visual spectrum data that is part of that field. In addition to natural language understanding, the aeromagnetic, aerogravity, and gravity survey corpora will require the incorporation and use of different geographic information system (GIS) software applications because they each have data in different formats. These corpora will also use deep learning algorithms to find correlations between gravity, magnetic, seismic, and satellite data to determine if prospective helium areas have a unique signature that could be detected in a new approach.

One last consideration for the overall detailed helium prospect corpus is that it will have significant bandwidth requirements due to the amount of information that will be ingested, particularly 3-D seismic data and satellite data. Like the Baseline Helium Geology Corpus discussed previously, some aspects of this corpus and the associated workflows will need to be updated periodically. The need and frequency for updating many of the individual contributing corpora will be less frequent as changes in the baseline knowledge seldom changes. Examples include the township corpus, converting latitude and longitude, and the pipeline corpus. Federal, State, and County drilling and well control guidelines will need to be updated regularly to ensure that no regulations are being broken. Other individual corpora, such as satellite data in all spectra, may need to be updated on a frequent basis to detect surface changes indicative of prospective well areas and likely drilling spots.

The process for automating well prospecting must include a method for acquiring data on wells that are newly filed with the state or federal regulatory agencies. The automation process must also incorporate a wide variety of data types from sub-contractors such as seismic, geochemical, and spectroscopy.

The automation of these specific corpora will require AI capabilities that are similar to the AI capabilities that are needed in the larger corpora discussed previously. The tools may well be identical in some instances because the information being ingested is the same format and from the same base of knowledge including seismic, geochemistry and spectroscopy. These corpora will need similar natural language understanding and image interpretation capabilities to understand the visual spectrum data that is a substantial component of the discipline. The tool will include capabilities such as Allen Institute's ARISTO, IBM DeepQA or OpenAI's GPT-3. The image interpretation tools that are applicable also include Google Vision AI, Microsoft InterpretML, and IBM AI Explainability 360.

Like the other corpora discussed previously, some aspects of this overall corpus and the associated workflows will need to be updated occasionally. The need and frequency for updating the individual contributing corpora will be less because the number of new wells entering the system is relatively small. Additionally, the frequency of large data transfers is also less; therefore, it is expected that this corpus will have smaller bandwidth requirements than the others.

The last overall corpus in automating the well prospecting process is the ingestion of a substantial database of wells that have been collected over a decades of operations. The database incorporates all of the data sources and data formats that the previously discussed overall corpora contain and is a part of current operations of the analogous or proxy company. The database has a file schema based on the API number of approximately 1200 wells that have been downloaded from state websites or given to the company for manual entry. The database also has a large spreadsheet keyed on the API number for the wells and details specifics on gas content with extensive quality control measures for hydrocarbon and helium mole percentages. The existing well overall corpus has the same AI capability needs as the other corpora and will be a substantial part of the training data for some of the AI functions.

In an embodiment of the present invention, there is a method of locating a well containing a helium supply comprising electronically harvesting and collecting a variety of data from a plurality of electronic data sources in a plurality of data formats to include but not be limited to federal government websites, Bureau of Land Management websites, state oil and gas conservation commissions websites, state geological society websites, Google scholar, Pipeline Association for Public Awareness website, Google Talk to Text website, EnergyNet website, commercial product pricing websites such as CME Group, Argus, OPIS, and Hart Energy, commercial visual, IR, SAR, LIDAR, and hyperspectral satellite data, and privately held electronic well data, storing said data in a plurality of storage network devices including but not limited to commercially available, off the shelf data storage systems, laptop and desktop computer storage drives, and external storage drives, electronically harvesting and collecting data from a plurality of printed data sources in a plurality of data formats to include but not be limited to, historical Bureau of Land Management reports, land leasing company records, natural gas exploration and production company records, helium exploration and production company records, pipeline company records, well operating company records, geochemical testing company records, spectroscopy testing company records, and privately held printed well data, scanning and storing said written data in a plurality of storage network devices including but not limited to commercially available, off the shelf data storage systems, laptop and desktop computer storage drives, and external storage drives, synthesizing and arranging said harvested data into an artificial intelligence knowledge corpus, electronically processing a plurality of scientific and technical topics, business framework conceptual topics, and theoretical topics to derive a set of criteria for evaluation of helium supply viability, and using a plurality of commercial, off the shelf AI capabilities, including but not limited to Google Vision AI, Cloud AutoML, IBM's AI Explainability 360 toolkit, and Microsofts' InterpretML, and evaluating said harvested data to locate an economically extractable helium supply and report thereupon.

In another embodiment, there is a method of synthesizing and arranging said harvested data into a county, state, or regional geology corpus of knowledge, electronically processing a plurality of technical and scientific conceptual topics and theoretical topics to derive a set of criteria for evaluation of a county, state, or regional geological setting for calculating the probability of finding said viable helium supply, and evaluating said geological setting and locating economically extractable helium supply and report thereupon.

In another embodiment, there is a method of synthesizing and arranging said harvested data into a county, state, or regional stratigraphic corpus of knowledge, electronically processing a plurality of technical and scientific conceptual topics and theoretical topics to derive a set of criteria for evaluation of a county, state, or regional stratigraphic setting for calculating the probability of finding said viable helium supply, and evaluating said stratigraphic setting and locating economically extractable helium supply and report thereupon.

In another embodiment, there is a method of synthesizing and arranging said harvested data into a reservoir or natural gas field or helium gas field corpus of knowledge, electronically processing a plurality of technical and scientific conceptual topics and theoretical topics to derive a set of criteria for evaluation of a reservoir or natural gas field or helium gas field for calculating the probability of finding said viable helium supply, and evaluating said reservoir or natural gas field or helium gas field and locating economically extractable helium supply and report thereupon.

In another embodiment, there is a method wherein synthesizing and arranging said harvested data into a regional natural gas or regional helium gas geology corpus of knowledge, electronically processing a plurality of technical and scientific conceptual topics) and theoretical topics to derive a set of criteria for evaluation of a regional natural gas or regional helium gas geological setting for calculating the probability of finding said viable helium supply, and evaluating said regional natural gas or regional helium gas geological setting and locating economically extractable helium supply and report thereupon.

In another embodiment, there is a method of synthesizing and arranging said harvested data into a state geographical corpus of knowledge, electronically processing a plurality of technical and scientific conceptual topics and theoretical topics to derive a set of criteria for evaluation of a regional natural gas or regional helium gas geological setting for calculating the probability of finding said viable helium supply, and evaluating said regional natural gas or regional helium gas geological setting and locating economically extractable helium supply and report thereupon.

In another embodiment, there is a method of synthesizing and arranging said harvested data into a pipeline corpus of knowledge, electronically processing a plurality of technical specifications to include a boundary condition and a technical detail of a pipe and geographic locations to derive a set of criteria for evaluation of a pipeline for calculating distances to said viable helium supply, and suitability for transport of said viable helium supply evaluating said pipeline corpus for use and transport of economically extractable helium supply and report thereupon.

In another embodiment, there is a method of synthesizing and arranging said harvested data into a geographic location and designation corpus of knowledge, electronically processing a plurality of technical and scientific conceptual topics and theoretical topics to derive a set of heuristics and geographical latitude and longitude transformations, and applying said geographic location and designation information for definitively locating said economically extractable helium supply and report thereupon.

In another embodiment, there is a method of synthesizing and arranging said harvested data into an aeromagnetic and aerogravity corpus of knowledge, electronically processing a plurality of technical and scientific conceptual topics and theoretical topics to derive a set of criteria for evaluation of an aeromagnetic and an aerogravity setting for calculating the probability of finding said viable helium supply, and evaluating said aeromagnetic and aerogravity setting and locating economically extractable helium supply and report thereupon.

In another embodiment, there is a method of synthesizing and arranging said harvested data into a geochemistry corpus of knowledge, electronically processing a plurality of technical and scientific conceptual topics and theoretical topics to derive a set of criteria for evaluation of a geochemistry setting for calculating the probability of finding said viable helium supply, and evaluating said geochemistry setting and locating economically extractable helium supply and report thereupon.

In another embodiment, there is a method according to synthesizing and arranging said harvested data into a spectroscopy corpus of knowledge, electronically processing a plurality of technical and scientific conceptual topics and theoretical topics to derive a set of criteria for evaluation of a spectroscopic setting for calculating the probability of finding said viable helium supply, and evaluating said spectroscopic setting and locating economically extractable helium supply and report thereupon.

In another embodiment, there is a method of synthesizing and arranging said harvested data into a 2-dimensional, 3-dimensional, and 4-dimensional seismic interpretation corpus of knowledge, electronically processing a plurality of technical and scientific conceptual topics and theoretical topics to derive a set of criteria for evaluation of a 2-dimensional, 3-dimensional, and 4-dimensional seismic setting for calculating the probability of finding said viable helium supply, and evaluating said 2-dimensional, 3-dimensional, and 4-dimensional seismic setting and locating economically extractable helium supply and report thereupon.

In another embodiment, there is a method of synthesizing and arranging said harvested data into a satellite imagery corpus of knowledge, electronically processing a plurality of technical and scientific conceptual topics and theoretical topics to derive a set of criteria for evaluation of satellite imagery for calculating the probability of finding said viable helium supply, and evaluating said satellite imagery and locating economically extractable helium supply and report thereupon.

In another embodiment, there is a method wherein synthesizing and arranging said harvested data into an American Petroleum Institute well designation corpus of knowledge, electronically processing a plurality of technical and scientific conceptual topics and theoretical topics to derive a set of heuristics and API designation transformations, and applying said geographic location and designation information for definitively identifying existing wells in or near said economically extractable helium supply and report thereupon.

In another embodiment, there is a method of synthesizing and arranging said harvested data into a federal, state, and local drilling and well control regulations corpus of knowledge, electronically processing a plurality of legal topics, technical and scientific conceptual topics and theoretical topics to derive a set of criteria for evaluation of federal, state, and local drilling and well control regulations for calculating the probability of finding said viable helium supply, and evaluating said federal, state, and local drilling and well control regulations and locating economically extractable helium supply and report thereupon.

In another embodiment, there is a method of synthesizing and arranging said harvested data into a federal agency data store well report corpus of knowledge, electronically processing a plurality of technical and scientific conceptual topics and theoretical topics to derive a set of criteria for evaluation of federal well reports for calculating the probability of finding said viable helium supply, and evaluating said federal well reports and locating economically extractable helium supply and report thereupon.

In another embodiment, there is a method of synthesizing and arranging said harvested data into a state-wide well corpus of knowledge, electronically processing a plurality of technical and scientific conceptual topics and theoretical topics to derive a set of criteria for evaluation of a state-wide well database for calculating the probability of finding said viable helium supply, and evaluating said state-wide well database and locating economically extractable helium supply and report thereupon.

In another embodiment, there is a method of synthesizing and arranging said harvested data into a well-specific corpus of knowledge, electronically processing a plurality of technical and scientific conceptual topics and theoretical topics to derive a set of criteria for evaluation of a specific well for calculating the probability of finding said viable helium supply, and evaluating said specific well and locating economically extractable helium supply and report thereupon.

In a preferred embodiment of the invention, there is a system and method for assessing extractability of prospective helium-natural gas sources comprising a well evaluation system to create a helium-extractability determination for a well comprising a plurality of extractability-criteria, one of said plurality of extractability-criteria comprising a viability-heuristic having a predictive-indicator, a plurality of information sources, one of said plurality of information sources being a geographic database, an algorithm, an input device, a database comprising said plurality of extractability-criteria, said plurality of information sources, an operational connection to a plurality of artificial intelligence data corpuses one of said plurality of artificial intelligence data corpuses being a helium-source-data corpus, and a processor, wherein a user uses said input device for collecting an electronically available data, wherein said processor uses said algorithm for organizing and storing said electronically available data among said plurality of information sources in said database, wherein said processor uses said algorithm for electronically harvesting and collecting said extractability-criteria from said plurality of information sources, and wherein said processor uses said algorithm for synthesizing and arranging said plurality of information sources and said extractability-criteria into an artificial intelligence knowledge corpus stored in said database, wherein said processor uses said algorithm for electronically processing a plurality of business framework conceptual topics and theoretical topics, one of said plurality of business framework conceptual topics and theoretical topics being said extractability-criteria comprising said viability-heuristic having said predictive-indicator then using said extractability-criteria to determine said helium-extractability by mining said artificial intelligence knowledge corpus for information to determine extractability-criteria based on said plurality of business framework conceptual topics and theoretical topics, and wherein said processor uses said algorithm for evaluating said well to report said helium-extractability determination.

In an alternative embodiment of the invention, there is a system and method for assessing extractability of prospective helium-natural gas sources comprising a well evaluation system to create a helium-extractability determination for a well wherein said artificial intelligence knowledge corpus and/or said further comprises an artificial intelligence neural network.

In an alternative embodiment of the invention, there is a system and method for assessing extractability of prospective helium-natural gas sources comprising a well evaluation system to create a helium-extractability determination for a well wherein a user uses said input device to enter a well-designation to identify a well and said well-designation is transmitted to said database in the form of non-transitory computer-readable media.

In an alternative embodiment of the invention, there is a system and method for assessing extractability of prospective helium-natural gas sources comprising a well evaluation system to create a helium-extractability determination for a well wherein said user further uses said input device for collecting a physically available data, wherein said processor uses said algorithm for organizing and storing said physically available data among said plurality of information sources in said database, wherein said processor uses said algorithm for electronically harvesting and collecting said extractability-criteria from said plurality of information sources, and wherein said processor uses said algorithm for synthesizing and arranging said plurality of information sources and said extractability-criteria into an artificial intelligence knowledge corpus stored in said database.

In a preferred embodiment of the invention, there is a method of creating a helium-extractability determination to determine whether a well contains an extractable-helium supply comprising identifying an information sources (IS) each IS having a plurality of evaluation-criteria (EC) each EC having a plurality of data-evaluation-elements (DEE) one of said plurality of DEE being for example a scaled value between zero and one then creating said EC from said DEE to identify an extractable-helium supply by creating a viability-heuristic (VH) having a plurality of predictive-indicators (PI) each based on applying a viability-rule (VR) to said DEE then repeating said creating a VH step to create a plurality of PI whose number is determined by the quantity present of said DEE then repeating said creating an EC step to create said plurality of EC as determined by the quantity present of said EC within each IS then repeating said identifying an IS step to create a plurality of IS, identifying a helium-source-data source (HSDS) having a plurality of data-elements (DE) then creating a helium-source-data corpus (HSDC) from said HSDS by capturing in an electronic format said plurality of DE, formatting said DE for a relational data storage, and importing said DE into said helium-source-data corpus, repeating said capturing in an electronic format step to import said plurality of DE, and repeating said identifying a HSDS step to create a plurality of HSDC, analyzing said plurality of HSDS using said plurality of EC, and generating said helium-extractability determination for said well.

In an alternative embodiment of the invention, there is a method of creating a helium-extractability determination to determine whether a well contains an extractable-helium supply wherein said analyzing said plurality of HSDS step and/or said helium-extractability determination step further comprises processing within an artificial intelligence knowledge corpus and/or an artificial intelligence neural network.

In a preferred embodiment of the invention, there is a method of creating a helium-extractability determination to determine whether a well contains a helium supply comprising collecting an electronic data source (EDS) having a plurality of data-elements (DE) related to helium-extractability and electronically harvesting/collecting said plurality of DE, synthesizing and arranging said plurality of DE into an artificial intelligence knowledge corpus, and repeating said collecting an EDS step to create a plurality of EDS, collecting an physical data source (PDS) having a plurality of data-elements (DE) related to helium-extractability and electronically harvesting/collecting said plurality of DE, synthesizing and arranging said plurality of DE into said artificial intelligence knowledge corpus, and repeating said collecting an PDS step to create a plurality of PDS, electronically mapping a plurality of business framework conceptual topics and theoretical topics to derive a set of helium supply viability criteria, evaluating said plurality of DE using said a set of helium supply viability criteria, and reporting said helium-extractability determination to locate an economically extractable helium supply and report thereupon.

In an alternative embodiment of the invention, there is a method of creating a helium-extractability determination to determine whether a well contains a helium supply wherein said artificial intelligence knowledge corpus further comprises an artificial intelligence neural network.

In an alternative embodiment of the invention, there is a method of creating a helium-extractability determination to determine whether a well contains a helium supply wherein said plurality of artificial intelligence data corpuses further comprises at least one of a geology corpus of knowledge, a stratigraphic corpus of knowledge, a gas field corpus of knowledge, a geographical corpus of knowledge, a pipeline corpus of knowledge, a geographic location and designation corpus of knowledge, an aerial magnetic and/or aerial gravity corpus of knowledge, a spectroscopy corpus of knowledge, a geochemistry corpus of knowledge, a 2-dimensional, 3-dimensional, and 4-dimensional seismic interpretation corpus of knowledge, a satellite imagery corpus of knowledge, an American Petroleum Institute well designation corpus of knowledge, a federal, state, and local drilling and well control regulations corpus of knowledge, a federal agency data store well report corpus of knowledge, a state-wide well corpus of knowledge, and/or a well-specific corpus of knowledge.

In an alternative embodiment of the invention, there is a method of creating a helium-extractability determination to determine whether a well contains a helium supply wherein plurality of information sources comprises at least one of federal government websites, Bureau of Land Management websites, state oil and gas conservation commissions websites, state geological society websites, Google scholar, Pipeline Association for Public Awareness website, Google Talk to Text website, EnergyNet website, commercial product pricing websites such as CME Group, Argus, OPIS, and Hart Energy, commercial visual, IR, SAR, LIDAR, hyper-spectral satellite data, or privately held electronic well data.

In an alternative embodiment of the invention, there is a method of creating a helium-extractability determination to determine whether a well contains a helium supply wherein plurality of information sources comprises up to all of historical Bureau of Land Management reports, land leasing company records, natural gas exploration and production company records, helium exploration and production company records, pipeline company records, well operating company records, geochemical testing company records, spectroscopy testing company records, or privately held printed well data,

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1. A method of creating a helium-extractability determination to determine whether a well contains an extractable-helium supply comprising
identifying an information sources (IS) each IS having a plurality of evaluation-criteria (EC) each EC having a plurality of data-evaluation-elements (DEE) one of said plurality of DEE being for example a scaled value between zero and one then
creating said EC from said DEE to identify an extractable-helium supply by
creating a viability-heuristic (VH) having a plurality of predictive-indicators (PI) each based on applying a viability-rule (VR) to said DEE then
repeating said creating a VH step to create a plurality of PI whose number is determined by the quantity present of said DEE then
repeating said creating an EC step to create said plurality of EC as determined by the quantity present of said EC within each IS then
repeating said identifying an IS step to create a plurality of IS,
identifying a helium-source-data source (HSDS) having a plurality of data-elements (DE) then
creating a helium-source-data corpus (HSDC) from said HSDS by
capturing in an electronic format said plurality of DE,
formatting said DE for a relational data storage,
importing said DE into said helium-source-data corpus,
repeating said capturing in an electronic format step to import said plurality of DE, and
repeating said identifying a HSDS step to create a plurality of HSDC,
analyzing said plurality of HSDS using said plurality of EC, and
generating said helium-extractability determination for said well.

2. The method of claim 1 wherein said analyzing said plurality of HSDS step and/or said helium-extractability determination step further comprises processing within an artificial intelligence knowledge corpus and/or an artificial intelligence neural network.

3. The method according to claim 2 wherein said artificial intelligence knowledge corpus further comprises at least one of
a geology corpus of knowledge,
a stratigraphic corpus of knowledge,
a gas field corpus of knowledge,
a geographical corpus of knowledge,
a pipeline corpus of knowledge,
a geographic location and designation corpus of knowledge,
an aerial magnetic and/or aerial gravity corpus of knowledge,
a spectroscopy corpus of knowledge,
a geochemistry corpus of knowledge,
a 2-dimensional, 3-dimensional, and 4-dimensional seismic interpretation corpus of knowledge,
a satellite imagery corpus of knowledge,
an American Petroleum Institute well designation corpus of knowledge,
a federal, state, and local drilling and well control regulations corpus of knowledge,
a federal agency data store well report corpus of knowledge,
a state-wide well corpus of knowledge, or
a well-specific corpus of knowledge.

4. The method of claim 1 wherein said plurality of IS comprises up to all of federal government websites, Bureau of Land Management websites, state oil and gas conservation commissions websites, state geological society websites, Google scholar, Pipeline Association for Public Awareness website, Google Talk to Text website, EnergyNet website, commercial product pricing websites such as CME Group, Argus, OPIS, and Hart Energy, commercial visual, IR, SAR, LIDAR, hyper-spectral satellite data, or privately held electronic well data.

5. The method of claim 1 wherein said plurality of IS comprises up to all of historical Bureau of Land Management reports, land leasing company records, natural gas exploration and production company records, helium exploration and production company records, pipeline company records, well operating company records, geochemical testing company records, spectroscopy testing company records, and privately held printed well data.

6. A method of creating a helium-extractability determination to determine whether a well contains a helium supply comprising
collecting an electronic data source (EDS) having a plurality of data-elements (DE) related to helium-extractability and electronically harvesting/collecting said plurality of DE,
synthesizing and arranging said plurality of DE into an artificial intelligence knowledge corpus,
repeating said collecting an EDS step to create a plurality of EDS,
collecting an physical data source (PDS) having a plurality of data-elements (DE) related to helium-extractability and electronically harvesting/collecting said plurality of DE,
synthesizing and arranging said plurality of DE into said artificial intelligence knowledge corpus,
repeating said collecting an PDS step to create a plurality of PDS,
electronically mapping a plurality of business framework conceptual topics and theoretical topics to derive a set of helium supply viability criteria,
evaluating said plurality of DE using said a set of helium supply viability criteria, and
reporting said helium-extractability determination to locate an economically extractable helium supply and report thereupon.

7. The method of claim 6 wherein said artificial intelligence knowledge corpus further comprises an artificial intelligence neural network.

8. The method according to claim 6 wherein said artificial intelligence knowledge corpus further comprises at least one of
a geology corpus of knowledge,
a stratigraphic corpus of knowledge,
a gas field corpus of knowledge,
a geographical corpus of knowledge,
a pipeline corpus of knowledge,
a geographic location and designation corpus of knowledge,
an aerial magnetic and/or aerial gravity corpus of knowledge,
a spectroscopy corpus of knowledge,
a geochemistry corpus of knowledge,
a 2-dimensional, 3-dimensional, and 4-dimensional seismic interpretation corpus of knowledge,
a satellite imagery corpus of knowledge,
an American Petroleum Institute well designation corpus of knowledge,
a federal, state, and local drilling and well control regulations corpus of knowledge,
a federal agency data store well report corpus of knowledge,
a state-wide well corpus of knowledge, or
a well-specific corpus of knowledge.

9. The method of claim 6 wherein said EDS comprises up to all of federal government websites, Bureau of Land Management websites, state oil and gas conservation commissions websites, state geological society websites, Google scholar, Pipeline Association for Public Awareness website, Google Talk to Text website, EnergyNet website, commercial product pricing websites such as CME Group, Argus, OPIS, and Hart Energy, commercial visual, IR, SAR, LIDAR, hyper-spectral satellite data, or privately held electronic well data.

10. The method of claim 6 wherein said PDS comprises up to all of historical Bureau of Land Management reports, land leasing company records, natural gas exploration and production company records, helium exploration and production company records, pipeline company records, well operating company records, geochemical testing company records, spectroscopy testing company records, and privately held printed well data.

11. A well evaluation system to create a helium-extractability determination for a well comprising
a plurality of extractability-criteria, one of said plurality of extractability-criteria comprising a viability-heuristic having a predictive-indicator,
a plurality of information sources, one of said plurality of information sources being a geographic database,
an algorithm,
an input device,
a database comprising
said plurality of extractability-criteria,
said plurality of information sources,
an operational connection to a plurality of artificial intelligence data corpuses one of said plurality of artificial intelligence data corpuses being a helium-source-data corpus,
a processor,
wherein a user uses said input device for collecting an electronically available data,
wherein said processor uses said algorithm for organizing and storing said electronically available data among said plurality of information sources in said database,
wherein said processor uses said algorithm for electronically harvesting and collecting said extractability-criteria from said plurality of information sources,
wherein said processor uses said algorithm for synthesizing and arranging said plurality of information sources and said extractability-criteria into an artificial intelligence knowledge corpus stored in said database,
wherein said processor uses said algorithm for electronically processing a plurality of business framework conceptual topics and theoretical topics, one of said plurality of business framework conceptual topics and theoretical topics being said extractability-criteria comprising said viability-heuristic having said predictive-indicator then using said extractability-criteria to determine said helium-extractability by mining said artificial intelligence knowledge corpus for information to determine extractability-criteria based on said plurality of business framework conceptual topics and theoretical topics, and
wherein said processor uses said algorithm for evaluating said well to report said helium-extractability determination.

12. The well evaluation system of of claim 11 wherein said artificial intelligence knowledge corpus and/or said further comprises an artificial intelligence neural network.

13. The well evaluation system of claim 11 wherein a user uses said input device to enter a well-designation to identify a well and said well-designation is transmitted to said database in the form of non-transitory computer-readable media.

14. The well evaluation system of claim 13 wherein said user further uses said input device for
collecting a physically available data,
wherein said processor uses said algorithm for organizing and storing said physically available data among said plurality of information sources in said database,
wherein said processor uses said algorithm for electronically harvesting and collecting said extractability-criteria from said plurality of information sources, and
wherein said processor uses said algorithm for synthesizing and arranging said plurality of information sources and said extractability-criteria into an artificial intelligence knowledge corpus stored in said database.

15. The well evaluation system of claim 11 wherein said plurality of artificial intelligence data corpuses further comprises at least one of
a geology corpus of knowledge,
a stratigraphic corpus of knowledge,
a gas field corpus of knowledge,
a geographical corpus of knowledge,
a pipeline corpus of knowledge,
a geographic location and designation corpus of knowledge,
an aerial magnetic and/or aerial gravity corpus of knowledge,
a spectroscopy corpus of knowledge,
a geochemistry corpus of knowledge,
a 2-dimensional, 3-dimensional, and 4-dimensional seismic interpretation corpus of knowledge,
a satellite imagery corpus of knowledge,
an American Petroleum Institute well designation corpus of knowledge,
a federal, state, and local drilling and well control regulations corpus of knowledge,
a federal agency data store well report corpus of knowledge,
a state-wide well corpus of knowledge, or
a well-specific corpus of knowledge.

16. The well evaluation system of claim 11 wherein plurality of information sources comprises at least one of federal government websites, Bureau of Land Management websites, state oil and gas conservation commissions websites, state geological society websites, Google scholar, Pipeline Association for Public Awareness website, Google Talk to Text website, EnergyNet website, commercial product pricing websites such as CME Group, Argus, OPIS, and Hart Energy, commercial visual, IR, SAR, LIDAR, hyper-spectral satellite data, or privately held electronic well data.

17. The well evaluation system of claim 11 wherein plurality of information sources comprises up to all of historical Bureau of Land Management reports, land leasing company records, natural gas exploration and production company records, helium exploration and production company records, pipeline company records, well operating company records, geochemical testing company records, spectroscopy testing company records, or privately held printed well data.
